(19) United States
(12) Patent Application Publication
(10) Pub. No.: US 2024/0320616 A1
(43) Pub. Date: Sep. 26, 2024

(54) SYSTEM FOR REGISTERING AN ITEM STORED IN A SHOPPING CART

(71) Applicant: Toshiba Tec Kabushiki Kaisha, Tokyo (JP)

(72) Inventor: Toshiki IWAI, Sunto Shizuoka (JP)

(21) Appl. No.: 18/472,133

(22) Filed: Sep. 21, 2023

(30) Foreign Application Priority Data
Mar. 22, 2023 (JP) 2023-045903

(51) Int. Cl. G06Q 10/087; G06V 10/44; G06V 10/74; G06V 20/52; H04N 23/61

(52) U.S. Cl. CPC G06Q 10/087; G06V 10/44; G06V 10/761; G06V 20/52; H04N 23/61

(57) ABSTRACT

A system for registering an item stored in a shopping cart in a store, includes beacons each configured to transmit a radio signal indicating item information, and a registration terminal attachable to the cart, including or connectable to a camera, and comprising: a network interface configured to communicate with the beacons, a memory that stores pieces of item information each in association with a feature value of an image of the corresponding item, and a processor configured to: upon receipt of a radio signal from a beacon, acquire item information therefrom, search the memory for a first feature value corresponding to the item information, control the camera to capture an image, and determine a second feature value of an item in the image, compare the first value with the second value, and register the item based on a comparison result of the first and second values.

### CROSS-REFERENCE TO RELATED APPLICATION

This application is based upon and claims the benefit of priority from Japanese Patent Application No. 2023-045903, filed Mar. 22, 2023, the entire contents of which are incorporated herein by reference.

### FIELD

Embodiments described herein relate generally to a system and method for registering an item stored in a shopping cart, and a registration terminal attachable to a shopping cart.

### BACKGROUND

In a known checkout system used by a shopper to purchase an item in a store, the shopper takes the item from a store shelf and operates, for example, a registration terminal attached to a cart to perform item registration on the spot. However, such a checkout system is complicated and requires the shopper to manually operate the registration terminal.

### BRIEF DESCRIPTION OF THE DRAWINGS

FIG. 1 is a perspective view of a shopping cart according to a first embodiment.

FIG. 2 is a hardware block diagram of an item registration assistance system according to the first embodiment.

FIG. 3 is an item table according to the first embodiment.

FIG. 4 is a flowchart illustrating an item registration process performed by a terminal according to the first embodiment.

FIG. 5 is a hardware block diagram of an item registration assistance system according to a second embodiment.

FIG. 6 is an item table according to the second embodiment.

FIG. 7 is an identification information table according to the second embodiment.

FIG. 8 is a flowchart illustrating an item registration process performed by a terminal according to the second embodiment.

FIG. 9 is a flowchart illustrating an item registration process performed by a server according to the second embodiment.

FIG. 10 is a diagram illustrating an arrangement of beacons according to a third embodiment.

FIG. 11 is a hardware block diagram of an item registration assistance system according to the third embodiment.

FIG. 12 is an item table according to the third embodiment.

FIG. 13 is a shelf table according to the third embodiment.

FIG. 14 is a flowchart illustrating an item registration process performed by a terminal according to the third embodiment.

### DETAILED DESCRIPTION

Hereinafter, embodiments will be described in detail with reference to the drawings. The present invention is not limited to the embodiments described below.

An aspect of this disclosure provides a system for registering an item stored in a shopping cart in a store, comprising: a plurality of beacons installed in the store and each configured to transmit a radio signal indicating item information that identifies an item displayed in the store; and a registration terminal attachable to the shopping cart, and including or connectable to a camera. The registration terminal comprises: a network interface configured to communicate with the beacons, a memory that stores a plurality of pieces of item information each in association with a feature value of an image of the corresponding item, and a processor configured to: upon receipt of a radio signal from one of the beacons via the network interface, acquire item information from the radio signal, search the memory for a first feature value corresponding to the acquired item information, control the camera to capture an image, and determine a second feature value of an item in the captured image, compare the first feature value with the second feature value, and register the item in the captured image based on a comparison result of the first and second feature values.

### First Embodiment

An item registration assistance system 1 according to a first embodiment is described below with reference to the drawings. In each of the drawings used to describe the embodiment below, some components may be omitted for brevity. Also, in the drawings and the descriptions below, the same reference number indicates the same or similar element.

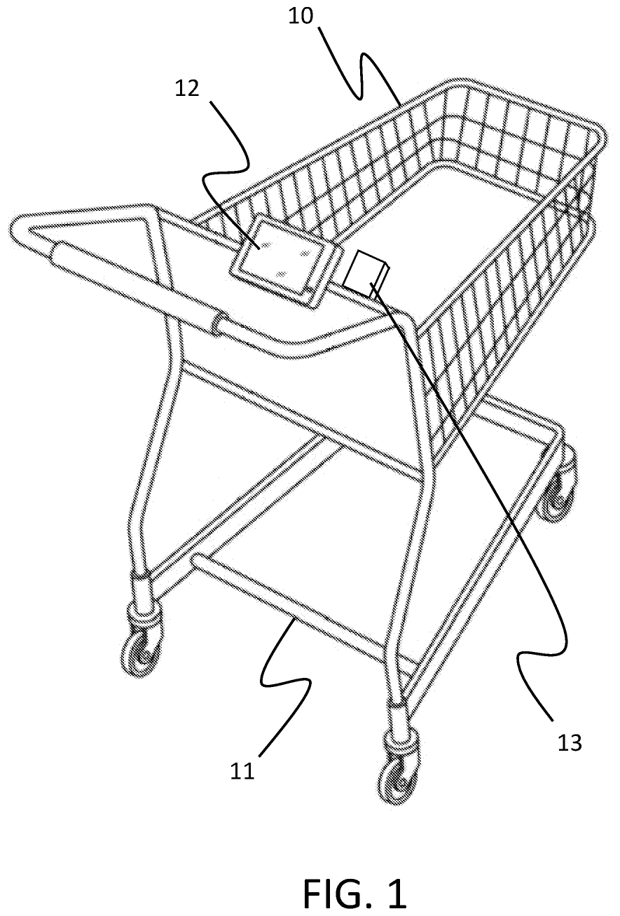

FIG. 1 is a perspective view of a shopping cart 10 according to the first embodiment. The shopping cart 10 is used, for example, by a shopper to carry items in a store such as a grocery store. For example, the shopping cart 10 is configured to enable a shopper to register an item to be purchased in an item list before placing the item in the shopping cart 10. This eliminates the need to register the item at a cash register. In the present embodiment, it is assumed that a shopper using the shopping cart 10 needs to be registered as a member. The shopping cart 10 includes a cart 11, a terminal 12, and a camera 13.

The cart 11 is used to hold and carry, for example, items and a shopping basket. The cart 11 includes, for example, wheels and a loading part on which items and a shopping basket are placed, and has general functions of a shopping cart.

The terminal 12 performs, for example, a process of displaying purchase information for a shopper, an item registration process, and a payment process. The terminal 12 is a mobile terminal attachable to the shopping cart 10. The terminal 12 may be implemented by, for example, a tablet terminal or a smartphone.

The camera 13 includes an imaging sensor and captures images of items to be purchased. The camera 13 is installed in a position where the camera 13 can capture an image of the entire loading part of the cart 11 on which items are placed. Also, the camera 13 is connected to the terminal 12 wirelessly or by wire. The camera 13 outputs light, which is focused on the image sensor, as an electric signal and generates image data by converting, compressing, and encoding the electric signal. After generating the image data, the camera 13 transmits the image data to the terminal 12. Also, in generating the image data, the camera 13 performs a development process including tone conversion, noise removal, and flaw correction. The camera 13 starts capturing images when communication is established with the terminal 12. In the present embodiment, the camera 13 that captures image data of items and the terminal 12 that performs processes related to item registration are provided as separate devices. However, the camera 13 may be integrated with the terminal 12. In other words, the terminal 12 may include a camera for capturing image data of items.

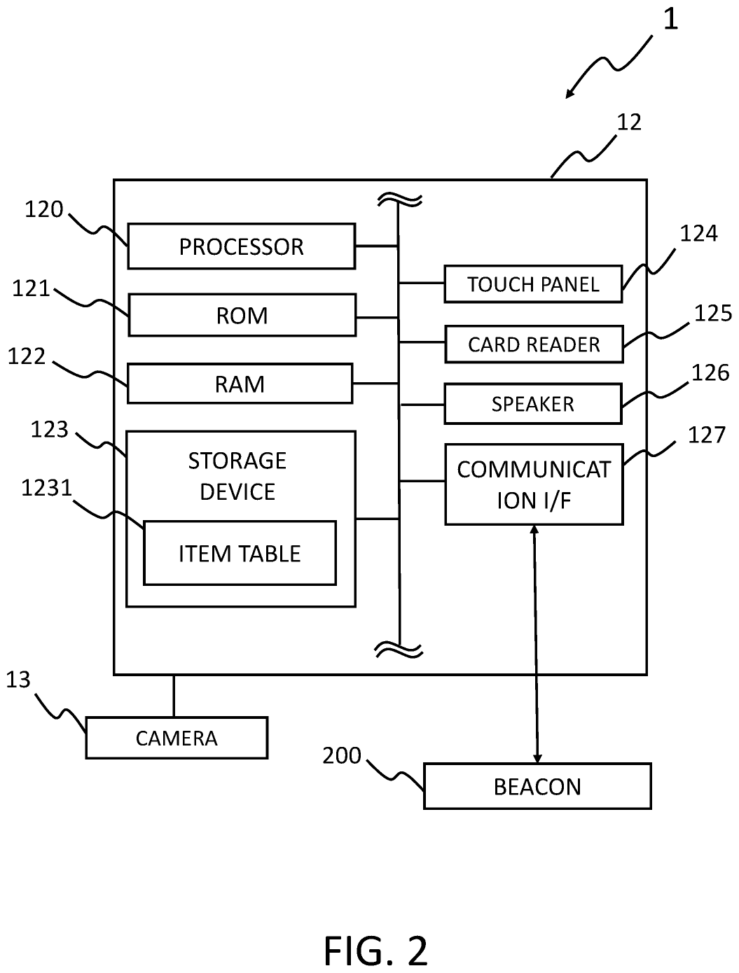

FIG. 2 is a hardware block diagram of the item registration assistance system 1. For example, the item registration assistance system 1 includes the terminal 12, the camera 13, and one or more beacons 200 that are connected to each other by wire or via a wireless local area network (LAN).

The terminal 12 includes, for example, a processor 120, a read-only memory (ROM) 121, a random access memory (RAM) 122, a storage device 123, a touch panel 124, a card reader 125, a speaker 126, and a communication interface (I/F) 127 that are connected to each other via a bus.

The processor 120 performs, for example, calculation and control processes necessary for the operation of the terminal 12. The processor 120 implements various functions based on various programs, software, and data stored in, for example, the ROM 121 and the storage device 123. Some or all of the programs may be stored in the circuit of the processor 120.

The processor 120 is, for example, a central processing unit (CPU), a microprocessor unit (MPU), a system-on-chip (SoC), a digital signal processor (DSP), a graphics processing unit (GPU), an application specific integrated circuit (ASIC), a programmable logic device (PLD), or a field programmable gate array (FPGA). Also, the processor 120 may be implemented by combining two or more of these devices.

The ROM 121 stores various programs, software, and data that implement various functions of the terminal 12 in conjunction with the processor 120. The ROM 121 is a non-volatile memory from which, for example, programs are read.

The RAM 122 is a volatile memory and used as a work area for the processor 120. Various types of software and data stored in the ROM 121 and the storage device 123 and data obtained from other components are loaded into the work area implemented by the RAM 122.

The processor 120 operates according to programs loaded into the RAM 122 to perform various processes such as identifying an item and registering the identified item. Also, the processor 120, according to programs, performs image recognition and identifies an item that is registered in an item table 1231 and corresponds to an item recognized by the image recognition.

Thus, the processor 120, the ROM121, and the RAM122 function as a controller that controls the operation of the terminal 12.

The storage device 123 stores various programs, software, and data that implement various functions of the terminal 12 in conjunction with the processor 120. The storage device 123 is a hard disk drive (HDD) or a non-volatile memory such as a solid state drive (SSD) or a flash memory. The storage device 123 stores, for example, the item table 1231.

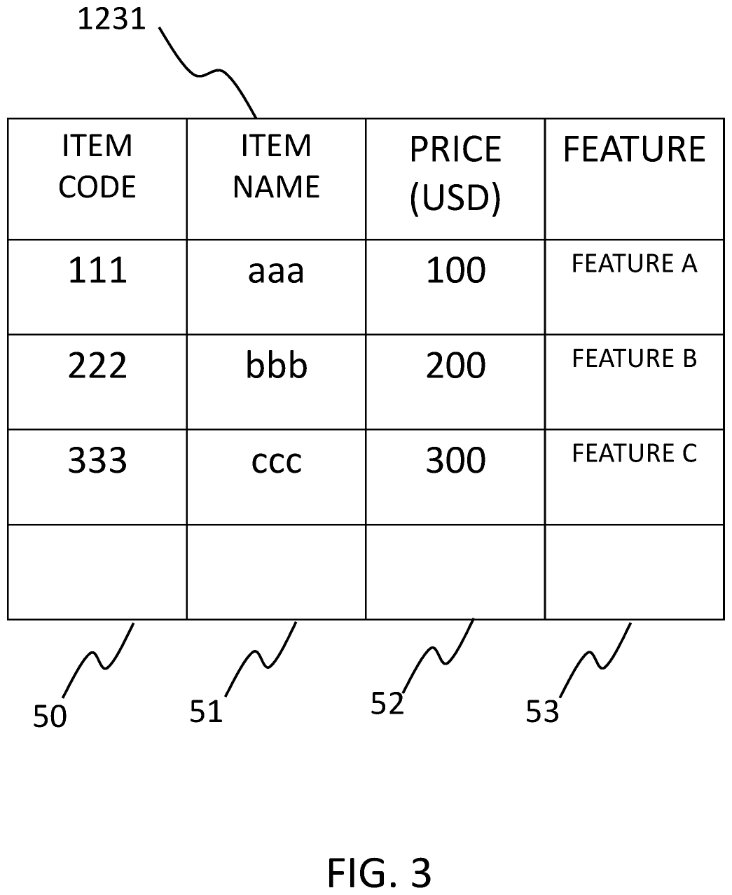

FIG. 3 is the item table 1231 according to the first embodiment. The item table 1231 stores information on items being sold in a store and information for identifying the items. Each item code recorded in an item code field 50 of the item table 1231 is associated with information recorded in an item name field 51, a price field 52, and a feature field 53. In addition to the information described above, the item table 1231 may store a flag indicating whether each item is a restricted item, such as an alcoholic beverage, the purchase of which by a customer not meeting a purchase condition is restricted and information, such as discount rates, related to the items.

The item code field 50 records an item code that is a unique identification code assigned to each type of item. The item code is, for example, a universal product code (UPC) or a price look-up (PLU) code. The item name field 51 records the name of each item associated with an item code. The price field 52 records an item price associated with each item. The feature field 53 records a feature of each item associated with an item code. In the present embodiment, a feature indicates a value representing a characteristic, such as a shape, a color, a color combination, or a letter, of an item and is used in an item registration process. The features recorded in the feature field 53 may also be used for machine learning used to improve the accuracy of a process for identifying an item.

The touch panel 124 is formed by, for example, stacking a touch-input pointing device on a display such as a liquid-crystal display or an organic electroluminescence (EL) display. The display of the touch panel 124 functions as a display device that displays screens to provide various types of information to an operator of the terminal 12. Also, the touch panel 124 functions as an input device that receives touch operations from the operator. Thus, the touch panel 124 functions as a display device that displays information and also functions as an input device that receives operations performed on the terminal 12.

The card reader 125 reads information from, for example, a magnetic card (e.g., a magnetic stripe card), a contact IC card, and a contactless IC card. Further, the card reader 125 communicates with, for example, a contactless IC chip included in an electronic device such as a cell phone, a smartphone, or a tablet PC. The card reader 125 may be externally attached to the terminal 12 or may be built in the terminal 12. The speaker 126 outputs an audio signal as a sound wave.

The communication I/F 127 is an interface circuit for communication with, for example, the beacon 200 installed in a store. The communication I/F 127 receives a radio wave transmitted by the beacon 200.

The beacon 200 transmits a radio wave at regular intervals. For example, the beacon 200 is built in a tag that is attached directly to an item or to a store shelf. The beacon 200 is compliant with, for example, Near Field Communication (NFC) or Bluetooth (registered trademark) Low Energy (BLE). Tag information is stored in the beacon 200, and a radio wave transmitted form the beacon 200 includes the tag information. The tag information includes an item code.

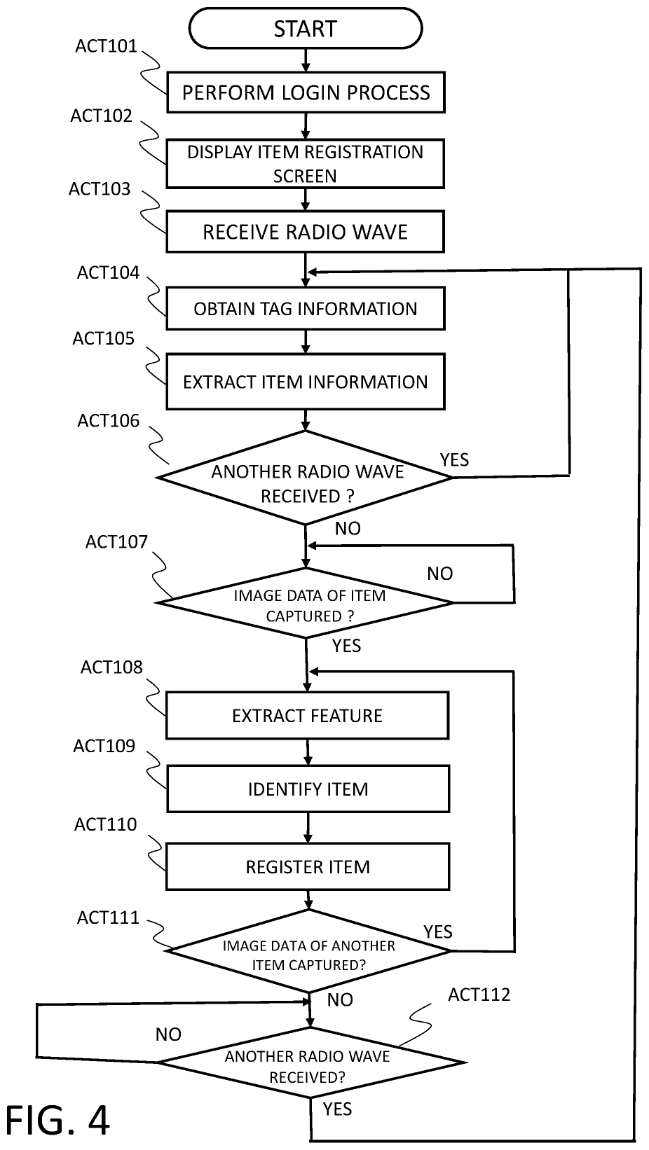

FIG. 4 is a flowchart illustrating an item registration process performed by the terminal 12 according to the first embodiment.

The processor 120 performs a login process (ACT 101). The processor 120 instructs the touch panel 124 to display information related to login, and upon receiving a login instruction from a customer, performs a process to cause the terminal 12 to transition to a login state.

The processor 120 controls the touch panel 124 to display an item registration screen indicating information related to item registration (ACT 102).

The communication I/F 127 receives a radio wave from a beacon 200, which is built in a tag attached to an item (ACT 103). Then, the processor 120 obtains tag information transmitted from the beacon 200 (ACT 104). The processor 120 extracts an item code from the obtained tag information and loads the item code into the RAM 122.

The processor 120 extracts item information (ACT 105). The processor 120 extracts item information related to the extracted item code from the item table 1231. For example, when the item code obtained from the beacon 200 is “111”, the processor 120 searches the item code field 50 of the item table 1231 for the item code “111” and extracts information including an item name “aaa”, a price “100”, and a feature “feature A” associated with the item code “111”. The extracted information is loaded into the RAM 122 by the processor 120.

The processor 120 determines whether another radio wave has been received (ACT 106). When another radio wave has been received (YES at ACT 106), the processor 120 returns to ACT 104 to obtain tag information in the other radio wave.

When another radio wave has not been received (NO at ACT 106), the processor 120 determines whether image data of an item has been captured by the camera 13 (ACT 107). When image data of an item has not been captured (NO at ACT 107), the process returns to ACT 107, and the processor 120 repeats ACT 107 until it is determined that image data of an item has been captured.

When image data of an item has been captured (YES at ACT 107), the processor 120 extracts a feature of the item from the image data (ACT 108).

The processor 120 identifies the item in the captured image data (ACT 109). The processor 120 compares the feature extracted from the image data with features obtained from multiples sets of tag information obtained from multiple beacons 200 and identifies the item in the captured image data based on one of the features that is closest to the feature extracted from the image data. For example, assume that an item code “111” and an item code “222” are obtained from tag information obtained from two beacons 200, and “feature A” and “feature B” corresponding to these item codes are loaded into the RAM 122. In this case, when the feature of the item extracted from the image data captured by the camera 13 is closer to “feature A”, the processor 120 identifies the item placed in the shopping cart 10 as an item with an item name “aaa”. If the communication I/F 127 receives only one beacon signal, the processor 120 may determine the item corresponding to the tag information indicated by the beacon signal to be the item in the captured image.

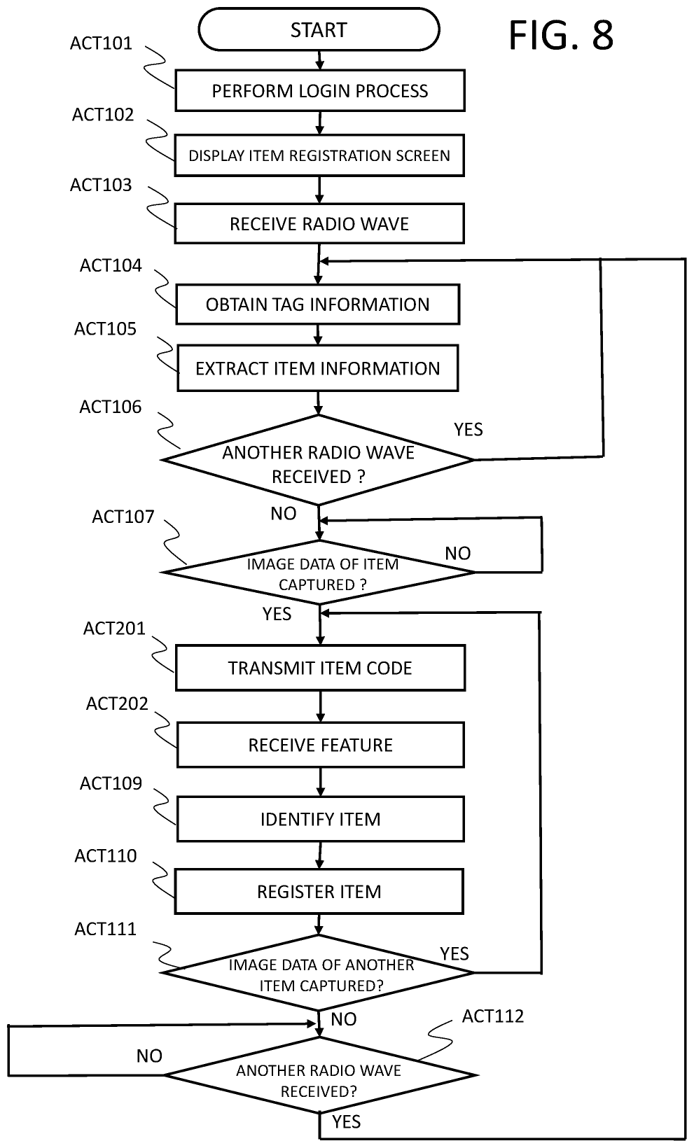

Regardless of the number of received beacon signals, the processor 120 may determine an item corresponding to tag information indicated by one of the beacon signals to be an item in a captured image when a difference between the feature value extracted from the image data and the feature value indicated by the tag information is smaller than a threshold. If such a difference is greater than or equal to the threshold, the processor 120 may determine that item identification has failed and go back to ACT 106 or ACT 107 instead of proceeding to ACT 110 (not shown in FIG. 8).

After identifying the item, the processor 120 performs item registration (ACT 110). The processor 120 extracts information related to the identified item from the information extracted at ACT 105 and stores the information related to the identified item in the RAM 122 or the storage device 123.

When image data of another item has been captured (YES at ACT 111), the processor 120 returns to ACT 108 to extract a feature from the image data.

When image data of another item has not been captured (NO at ACT 111) but another radio wave has been received (YES at ACT 112), the processor 120 returns to ACT 104.

In the embodiment described above, the terminal 12 identifies an item and registers the identified item. This configuration makes it possible to reduce operations that need to be performed by a customer for item registration.

### Second Embodiment

According to a second embodiment, information such as a feature, which is used by the terminal 12 included in the item registration assistance system 1 to identify an item, is obtained from an external device connected to the terminal 12.

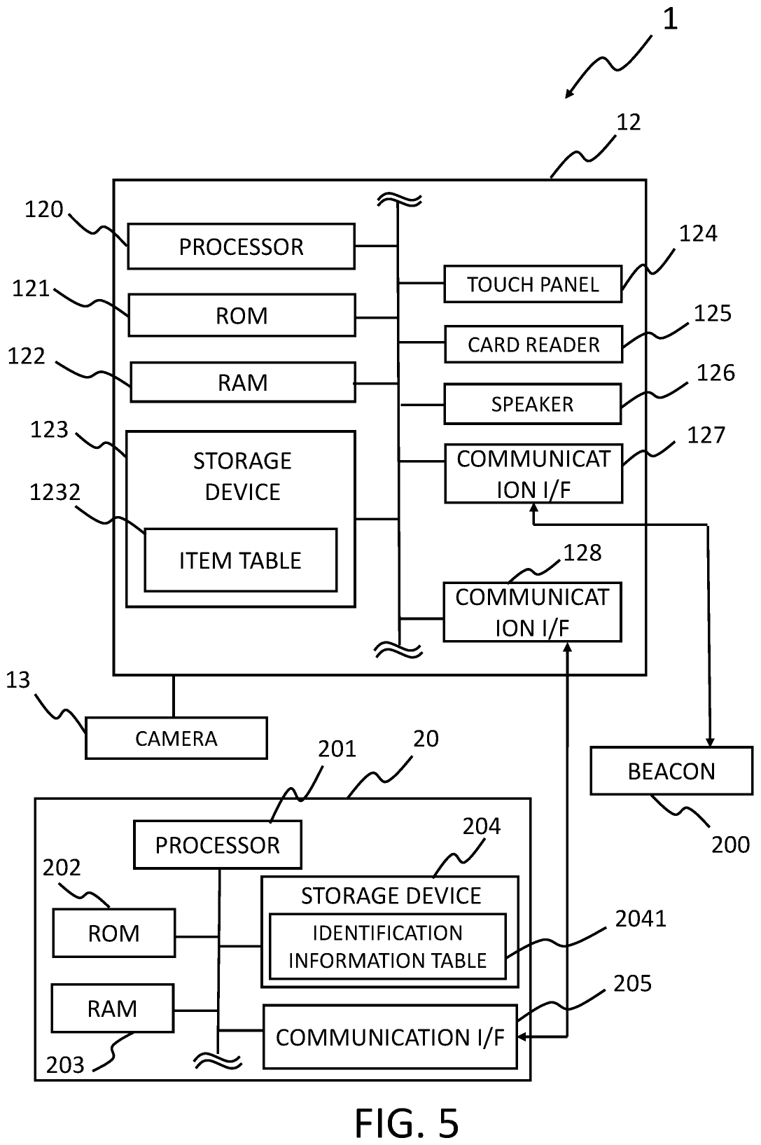

FIG. 5 is a hardware block diagram of the item registration assistance system 1 according to the second embodiment. The item registration assistance system 1 of the second embodiment includes, for example, the terminal 12, the camera 13, the beacon 200, and a server 20 that are connected to each other by wire or via a wireless LAN.

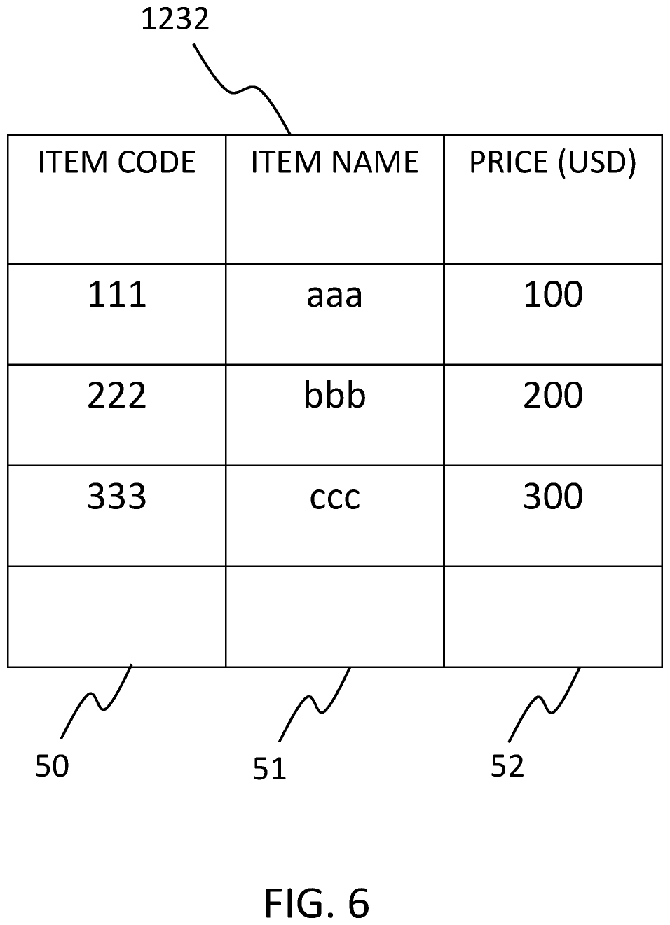

The storage device 123 of the terminal 12 stores an item table 1232. For example, the item table 1232 includes fields, such as the item code field 50, the item name field 51, and the price field 52 illustrated in FIG. 6, that record information related to items sold in a store. Each item code, which is recorded in the item code field 50 of the item table 1232, is associated with information recorded in the item name field 51 and the price field 52. In addition to the information described above, the item table 1232 may store a flag indicating whether each item is a restricted item, such as an alcoholic beverage, the purchase of which by a customer not meeting a purchase condition is restricted and information, such as discount rates, related to the items.

A communication I/F 128 is a network interface circuit for the terminal 12 to communicate with, for example, the server 20 via a network. The network is, for example, a LAN and/or the Internet.

The server 20 manages information related to one or more stores. The server 20 includes a processor 201, a ROM 202, a RAM 203, a storage device 204, and a communication I/F 205 that are connected to each other via a bus.

The processor 201 performs, for example, calculation and control processes necessary for the operation of the server 20. The processor 201 performs various functions based on various programs, software, and data that are stored in, for example, the ROM 202 or the storage device 204. Some or all of the programs may be incorporated in the circuit of the processor 201. The processor 201 is, for example, a central processing unit (CPU), a microprocessor unit (MPU), a system-on-chip (SoC), a digital signal processor (DSP), a graphics processing unit (GPU), an application specific integrated circuit (ASIC), a programmable logic device (PLD), or a field programmable gate array (FPGA). Also, the processor 201 may be implemented by combining two or more of these devices.

The ROM 202 stores various programs, software, and data that implement various functions of the server 20 in conjunction with the processor 201. The ROM 202 is a non-volatile memory from which, for example, programs are read.

The RAM 203 is a volatile memory and used as a work area for the processor 201. Various types of software and data stored in the ROM 202 and the storage device 204 and data obtained from other components are loaded into the work area implemented by the RAM 203.

The processor 201 operates according to the programs loaded into the RAM 203 and thereby performs processes for managing information related to stores. Also, the processor 201, according to the programs, controls the communication I/F 205 to transmit, to the terminal 12, information necessary to identify an item and information related to a payment process.

Thus, the processor 201, the ROM 202, and the RAM 203 function as a controller that controls the operation of the server 20.

The storage device 123 stores various programs, software, and data for implementing various functions of the terminal 12 in conjunction with the processor 120. The storage device 123 is an HDD or a non-volatile memory such as an SSD or a flash memory. The storage device 123 stores, for example, an identification information table 2041.

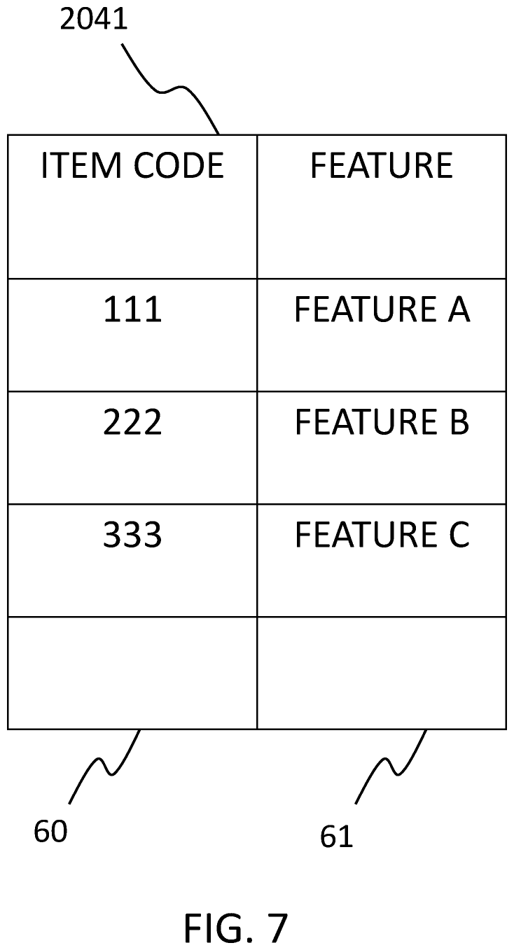

FIG. 7 is the identification information table 2041 according to the second embodiment. The identification information table 2041 records information for identifying items. Each item code recorded in an item code field 60 of the identification information table 2041 is associated with information recorded in a feature field 61. The identification information table 2041 may record, in addition to features in the feature field 61, information, such as image data of the front side, the lateral side, and the bottom of each item, used to identify items captured by the camera 13.

The communication I/F 205 is a network interface circuit for the server 20 to communicate with an external device via, for example, a network.

FIG. 8 is a flowchart illustrating an item registration process performed by the terminal 12 according to the second embodiment. Below, descriptions of steps identical to the steps described in the first embodiment are omitted.

When identifying item information (ACT 105) after receiving a radio wave, the processor 120 identifies an item in the item table 1232 related to an obtained item code. For example, when the item code obtained from the beacon 200 is “111”, the processor 120 searches the item code field 50 of the item table 1232 for the item code “111” and identifies an item by extracting information including the item name “aaa” and the price “100” that are associated with the item code “111”. Also, the extracted information is loaded into the RAM 122 by the processor 120.

After identifying the item information and capturing image data of an item (YES at ACT 107), the processor 120 controls the communication I/F 128 to transmit the item code (ACT 201). The processor 120 extracts the item code from the item information extracted at ACT 105 and controls the communication I/F 128 to transmit the extracted item code to the server 20.

The processor 120 acquires a feature (i.e., a value) that is stored in the server 20 and associated with the item code transmitted by the processor 120 (ACT 202).

After receiving the feature, the processor 120 identifies the item in the captured image data (ACT 109). The processor 120 compares the acquired feature with a feature extracted from the image data and identifies the item in the captured image data based on the received feature that is closest to the feature extracted from the image data.

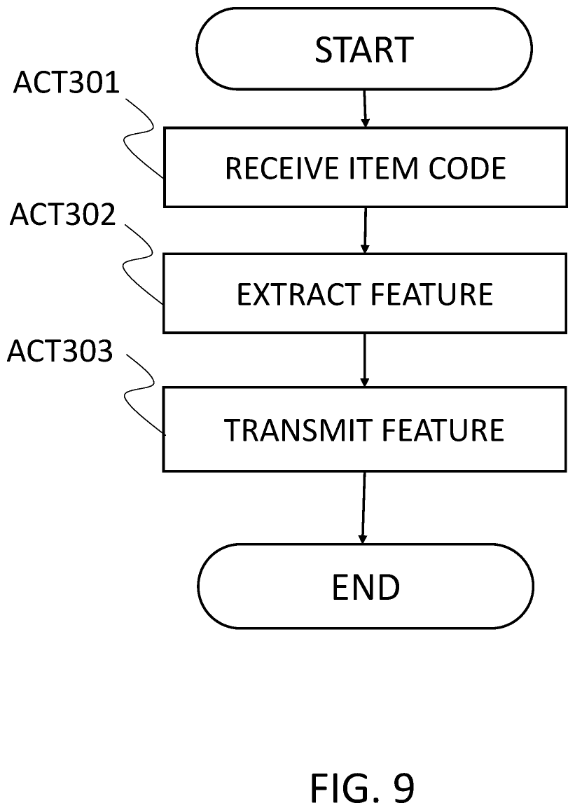

Next, a process performed by the server 20 is described. FIG. 9 is a flowchart illustrating an item registration process performed by the server 20 according to the second embodiment.

The processor 201 acquires an item code via the communication I/F 205 (ACT 301).

The processor 201 extracts a feature (ACT 302). The processor 201 refers to the identification information table 2041 and extracts a feature associated with an item code corresponding to the obtained item code.

The processor 201 controls the communication I/F 205 to transmit, to the terminal 12, the extracted feature (ACT 303).

In the second embodiment, similarly to the first embodiment, the terminal 12 identifies an item and registers the identified item. This configuration makes it possible to reduce operations that need to be performed by a customer for item registration. Also, in the second embodiment, information for identifying items is not stored in the terminal 12. In a store where multiple terminals 12 are used, this configuration eliminates the need to update the item table 1231 stored in each of the terminals 12 every time items sold at the store are changed and thereby makes it possible to reduce the load of store clerks or users using the terminals 12.

### Third Embodiment

A third embodiment is described below. The same reference numbers as those assigned to the components in the first embodiment and the second embodiment are assigned to the corresponding components in the third embodiment. In the third embodiment, the processor 120 obtains, based on the current location of the terminal 12, a feature to be compared with a feature extracted from image data.

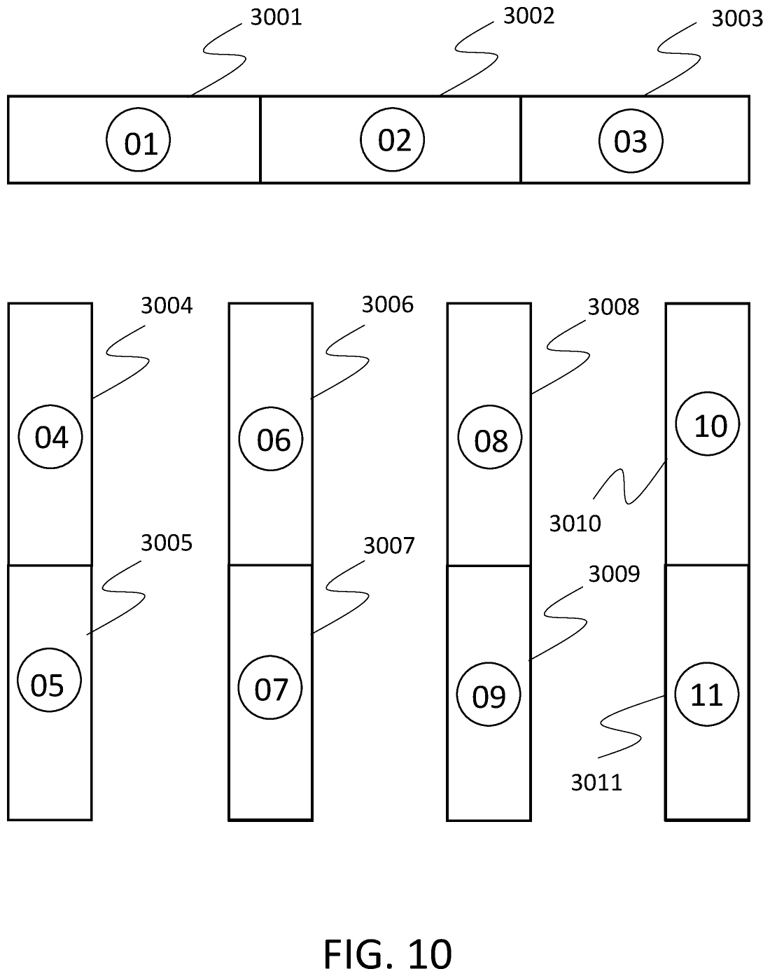

In the third embodiment, for example, shelves for displaying items and beacons 300 that transmit radio waves are arranged in a store as illustrated in FIG. 10. A beacon 300 is attached to each shelf. A unique beacon code is stored in each beacon 300. Also, the radio wave transmitted by each beacon 300 includes a beacon code. This configuration makes it possible to identify a shelf near which a customer using the terminal 12 is located. In the present embodiment, it is assumed that one beacon is attached to one shelf. However, multiple beacons 300 may be attached to one shelf. Also, the arrangement of the beacons 300 attached to the shelves is not limited to any specific arrangement.

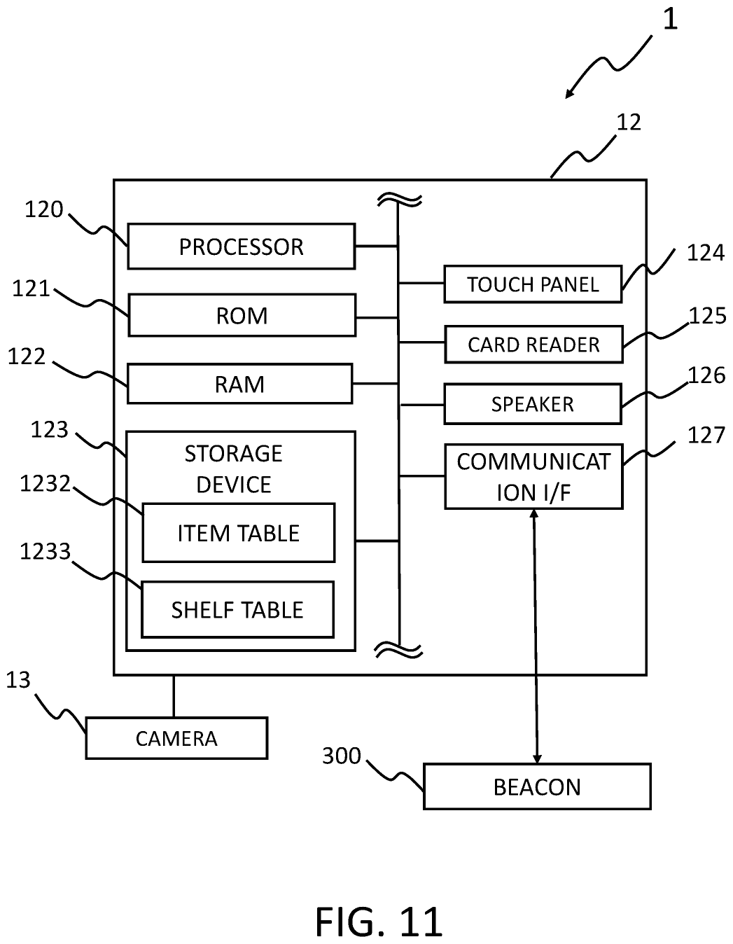

FIG. 11 is a hardware block diagram of the item registration assistance system 1 according to the third embodiment. The storage device 123 stores an item table 1232 and a shelf table 1233.

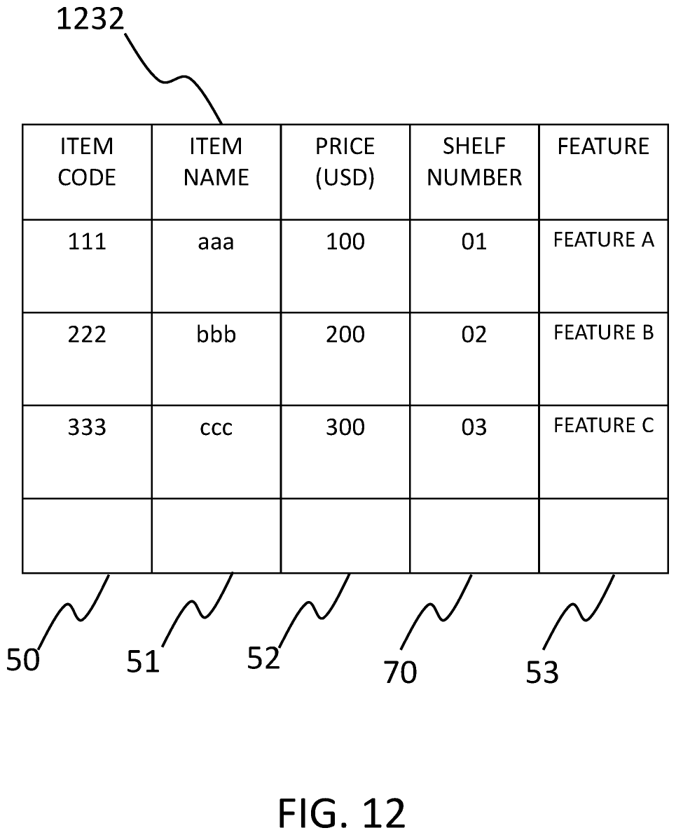

As illustrated in FIG. 12, the item table 1232, for example, includes an item code field 50, an item name field 51, a price field 52, a shelf number field 70, and a feature field 53 that are associated with each other. The shelf number field 70 records a unique identification number or a shelf number assigned to each shelf in the store. In the third embodiment, for example, numbers 1 to 11 are assigned to shelves 3001 to 3011 as illustrated in FIG. 10 as shelf numbers recorded in the shelf number field 70.

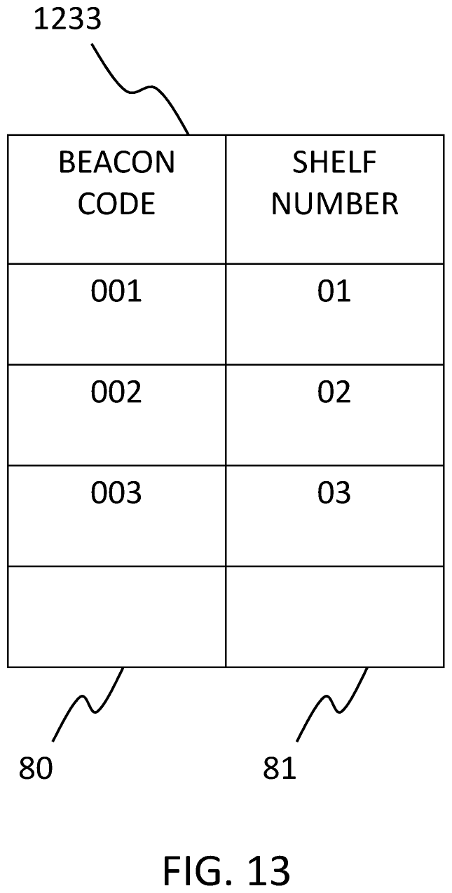

Next, the shelf table 1233 is described. For example, as illustrated in FIG. 13, the shelf table 1233 includes two fields: a beacon code field 80 and a shelf number field 81. The beacon code field 80 records beacon codes that are unique identification codes for identifying beacons 300 attached to the shelves. Each beacon code is represented by a sequence comprised of letters and/or numbers such as alphanumeric characters. The beacon code is also stored in the beacon 300 attached to each shelf. The shelf number field 81 records unique identification numbers or shelf numbers assigned to the respective shelves in the store. The beacon codes in the beacon code field 80 are associated with the shelf numbers in the shelf number field 81.

Each beacon 300 is attached to a shelf in the store. The beacon 300 transmits a radio wave at regular intervals. The beacon 300 is compliant with, for example, NFC or BLE. A beacon code is stored in the beacon 300, and the radio wave transmitted by the beacon 300 includes the beacon code.

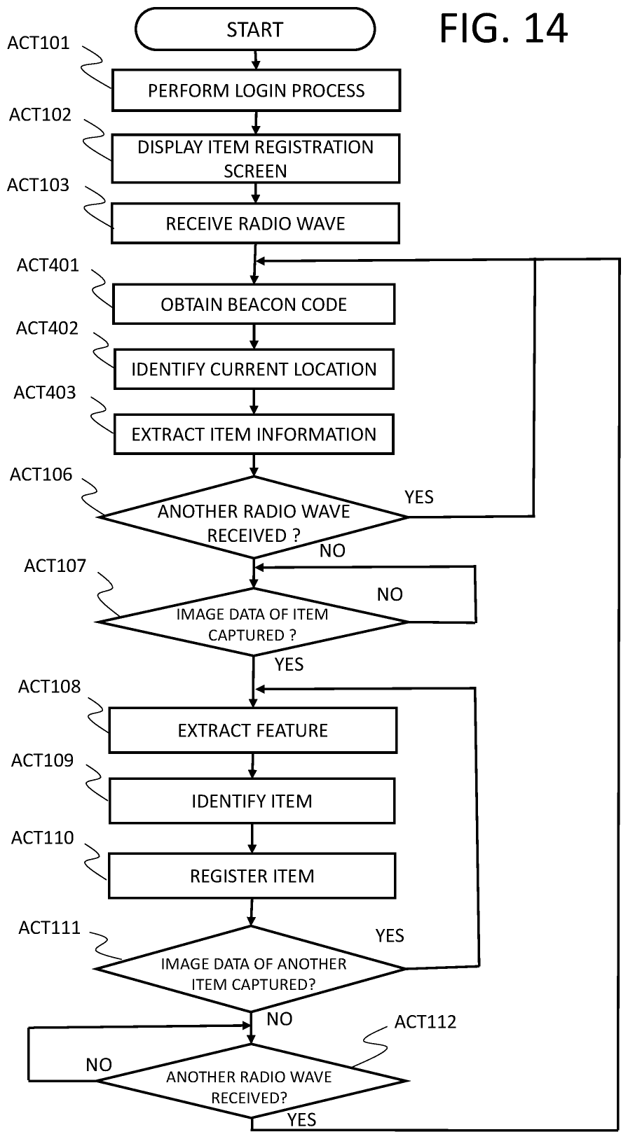

Next, an item registration process performed by the terminal 12 according to the third embodiment is described. FIG. 14 is a flowchart illustrating an item registration process performed by the terminal 12 according to the third embodiment. Below, descriptions of steps identical to the steps described in the first embodiment are omitted.

The communication I/F 127 receives a radio wave from the beacon 300 attached to a shelf (ACT 103). The processor 120 obtains a beacon code from the radio wave transmitted from the beacon 300 (ACT 401). The processor 120 stores the obtained beacon code in the RAM 122.

The processor 120 identifies the current location of the terminal 12 (ACT 402). The processor 120 identifies the current location by performing two processes described below. The processor 120 extracts a beacon code from a radio wave with a radio field intensity greater than or equal to a predetermined threshold. More specifically, the processor 120 measures the intensities of received radio waves. Based on the measured intensities, the processor 120 classifies the received radio waves into a radio wave with an intensity greater than or equal to the predetermined threshold and a radio wave with an intensity less than the predetermined threshold. In the present embodiment, a beacon 300 transmitting a radio wave with an intensity close to or greater than the threshold is assumed to be located near the terminal 12. Also, a beacon 300 transmitting a radio wave with an intensity less than the threshold is assumed to be located far from the terminal. After classifying the received radio waves based on the radio field intensities, the processor 120 extracts a beacon code from the radio wave with an intensity greater than or equal to the threshold.

The processor 120 extracts item information (ACT 403). The processor 120 extracts a shelf number associated with the extracted beacon code from the shelf table 1233. After extracting the shelf number, the processor 120 extracts a feature associated with the extracted shelf number from the item table 1232.

After extracting the feature, the processor 120 performs steps similar to those in the first embodiment.

Also in the third embodiment, the terminal 12 identifies an item and registers the identified item. This configuration makes it possible to reduce operations that need to be performed by a customer for item registration. Also, because beacons are attached to shelves instead of items, the present embodiment eliminates the need for a customer to perform operations to register an item even when a beacon cannot be attached to the item.

The present invention is not limited to the above embodiments, and various modifications may be made to the above embodiments. For example, the processor 120 described in the first embodiment or the second embodiment may be configured to extract tag information from a radio wave that is transmitted from the beacon 200 and has a radio field intensity greater than or equal to a predetermined threshold and extract item information based on the tag information. The radio field intensity indicates the intensity of a radio wave between the terminal 12 and the beacon 200. In this case, the radio field intensity is associated with the item code. The processor 120 determines the radio field intensity of a radio wave transmitted from the beacon 200. When the distance between the beacon 200 and the terminal 12 is short and the radio field intensity is greater than or equal to a predetermined threshold, the processor 120 determines that the radio field intensity is high. When the distance between the beacon 200 and the terminal 12 is long and the radio field intensity is less than the predetermined threshold, the processor 120 determines that the radio field intensity is low. When identifying an item, the processor 120 obtains tag information of a beacon 200 that has transmitted a radio wave with a radio field intensity greater than or equal to the predetermined threshold. According to this variation, when identifying an item, the processor 120 does not perform a process related to tag information of a beacon 200 located far from the shopping cart 10. This makes it possible to improve the processing speed of item registration.

Also, in this variation, the processor 120 may be configured to preferentially extract tag information of a beacon 200 that has transmitted a radio wave with a radio field intensity greater than or equal to the predetermined threshold. This makes it possible to identify an item by preferentially using tag information obtained from a beacon 200 located close to the shopping cart 10 or the terminal 12 when the item is placed in the shopping cart 10 and thereby makes it possible to improve the processing speed of item registration.

When the terminal 12 is connected to, for example, a server for store management, the above process may be performed by the server.

In the third embodiment, the processor 120 may be configured to determine the current location of the terminal 12 based on two or more beacon codes. In this variation, a store has two or more areas to which unique numbers (hereafter referred to as “area numbers”) are assigned, and a table (hereafter referred to as an “area table”) recording the area numbers is stored. Each area number recorded in the area table is associated with a unique combination of two or more beacon codes.

At ACT 402, the processor 120 extracts two or more beacon codes from radio waves with radio field intensities greater than or equal to a predetermined threshold and extracts an area number corresponding to the combination of the extracted beacon codes from the area table. With this variation, because processes related to items, which are displayed on shelves having beacons 300 located away from the shopping cart 10, are not performed during item identification, the processing speed of item registration is improved.

In a registration terminal and a registration method according to at least one of the embodiments described above, the terminal 12 identifies an item and registers the identified item. This configuration makes it possible to reduce operations that need to be performed by a customer for item registration.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A system for registering an item stored in a shopping cart in a store, comprising:
a plurality of beacons installed in the store and each configured to transmit a radio signal indicating item information that identifies an item displayed in the store; and
a registration terminal attachable to the shopping cart, including or connectable to a camera, and comprising:
a network interface configured to communicate with the beacons,
a memory that stores a plurality of pieces of item information each in association with a feature value of an image of the corresponding item, and
a processor configured to:
upon receipt of a radio signal from one of the beacons via the network interface, acquire item information from the radio signal,
search the memory for a first feature value corresponding to the acquired item information,
control the camera to capture an image, and determine a second feature value of an item in the captured image,
compare the first feature value with the second feature value, and
register the item in the captured image based on a comparison result of the first and second feature values.

2. The system according to claim 1, wherein the processor registers the item in the captured image when a difference between the first and second feature values is smaller than a threshold.

3. The system according to claim 1, wherein the processor is configured to:
upon receipt of radio signals from two of the beacons via the network interface, acquire two pieces of item information from the radio signals,
search the memory for third and fourth feature values corresponding to the two pieces of item information,
control the camera to capture an image, and determine a fifth feature value of an item in the captured image,
determine which of the third and fourth feature values is closer to the fifth feature value, and
register the item corresponding to one of the third and fourth feature values that is closer to the fifth feature value.

4. The system according to claim 1, further comprising:
a server that stores a plurality of pieces of item information each in association with a feature value of an image of the corresponding item, wherein
the network interface is configured to communicate with the server, and
the processor is configured to control the network interface to transmit the item information acquired from the radio signal to the server, and acquire the first feature value corresponding to the acquired item information from the server.

5. The system according to claim 4, wherein the processor configured to, before controlling the network interface to transmit the item information:
acquire a radio field intensity of the radio signal, and
determine that the radio field intensity is greater than or equal to a threshold.

6. The system according to claim 1, wherein the processor configured to, before searching the memory:
acquire a radio field intensity of the radio signal, and
determine that the radio field intensity is greater than or equal to a threshold.

7. The system according to claim 1, wherein
the radio signal transmitted from each beacon indicates a feature value of an image of an item, and
the processor is configured to:
upon receipt of a radio signal from one of the beacons via the network interface, acquire a third feature value from the radio signal,
control the camera to capture an image, and determine a fourth feature value of an item in the captured image,
compare the third feature value with the fourth feature value, and
register the item in the captured image based on a comparison result of the third and fourth feature values.

8. The system according to claim 7, wherein the processor registers the item in the captured image when a difference between the third and fourth feature values is smaller than a threshold.

9. The system according to claim 1, wherein
the radio signal transmitted from each beacon indicates a feature value of an image of an item, and
the processor is configured to store in the memory the plurality of pieces of item information in association with the feature values of the items included in the radio signals transmitted from the plurality of beacons.

10. The system according to claim 1, further comprising:
a shelf on which an item is displayed and to which a beacon is attached, wherein the beacon is configured to transmit a radio signal indicating item information of the item.

11. A method for registering an item stored in a shopping cart in a store, the method comprising:
storing, in a memory of a registration terminal attached to the shopping cart, a plurality of pieces of item information each identifies an item and associated with a feature value of an image of the item;
transmitting, from each of a plurality of beacons installed in the store, a radio signal indicating item information that identifies an item displayed in the store;
receiving, by the registration terminal, a radio signal from one of the beacons, and acquiring item information from the radio signal;
searching the memory for a first feature value corresponding to the acquired item information;
capturing an image by a camera and determining a second feature value of an item in the captured image;
comparing the first feature value with the second feature value; and
registering the item in the captured image based on a comparison result of the first and second feature values.

12. The method according to claim 11, wherein registering the item includes determining that a difference between the first and second feature values is smaller than a threshold, and then registering the item in the captured image.

13. The method according to claim 11, further comprising:
receiving, by the registration terminal, radio signals from two of the beacons, and acquiring two pieces of item information from the radio signals;
searching the memory for third and fourth feature values corresponding to the two pieces of item information;
capturing an image by the camera and determining a fifth feature value of an item in the captured image;
determining which of the third and fourth feature values is closer to the fifth feature value; and
registering the item corresponding to one of the third and fourth feature values that is closer to the fifth feature value.

14. The method according to claim 11, further comprising:
storing, in a server, a plurality of pieces of item information each in association with a feature value of an image of the corresponding item; and
transmitting the item information acquired from the radio signal to the server, and acquiring the first feature value corresponding to the acquired item information from the server.

15. The method according to claim 14, further comprising:
before transmitting the item information to the server, acquiring a radio field intensity of the radio signal, and determining that the radio field intensity is greater than or equal to a threshold.

16. The method according to claim 11, further comprising:
before searching the memory, acquiring a radio field intensity of the radio signal, and determining that the radio field intensity is greater than or equal to a threshold.

17. The method according to claim 11, wherein
the radio signal transmitted from each beacon indicates a feature value of an image of an item, and
the method further comprises:
receiving a radio signal from one of the beacons, and acquiring a third feature value from the radio signal;
capturing an image by the camera, and determining a fourth feature value of an item in the captured image;
comparing the third feature value with the fourth feature value; and
registering the item in the captured image based on a comparison result of the third and fourth feature values.

18. The method according to claim 17, wherein registering the item includes determining that a difference between the third and fourth feature values is smaller than a threshold, and then registering the item in the captured image.

19. The method according to claim 11, wherein
the radio signal transmitted from each beacon indicates a feature value of an image of an item, and
storing includes storing the plurality of pieces of item information in association with the feature values of the items included in the radio signals transmitted from the plurality of beacons.

20. A registration terminal attachable to a shopping cart for registering an item stored in the shopping cart in a store, comprising:
a network interface configured to communicate with a plurality of beacons installed in the store;
a memory that stores a plurality of pieces of item information each in association with a feature value of an image of the corresponding item; and
a processor configured to:
upon receipt of a radio signal from one of the beacons via the network interface, acquire item information from the radio signal,
search the memory for a first feature value corresponding to the acquired item information,
control a camera to capture an image, and determine a second feature value of an item in the captured image,
compare the first feature value with the second feature value, and
register the item in the captured image based on a comparison result of the first and second feature values.
